(19) United States
(12) Patent Application Publication
(10) Pub. No.: US 2014/0302187 A1
(43) Pub. Date: Oct. 9, 2014

(54) POWDER DAM FOR POWDER BED LASER SINTERING DEVICE

(71) Applicant: TYCO ELECTRONICS CORPORATION, Berwyn, PA (US)

(72) Inventors: Gregory Thomas Pawlikowski, Windsor, PA (US); Joseph David Locondro, Jacobus, PA (US)

(73) Assignee: Tyco Electronics Corporation, Berwyn, PA (US)

(21) Appl. No.: 13/856,990

(22) Filed: Apr. 4, 2013

(51) Int. Cl. B29C 67/00

(52) U.S. Cl. CPC B29C 67/0085; B29C 67/0077
USPC 425/174.4

(57) ABSTRACT

A powder bed laser sintering (PBLS) device includes a build chamber having a build area defined over a build plate. The build area is bounded by a plurality of walls comprising first and second end walls and first and second side walls extending between the first and second end walls. The build plate is movable relative to the plurality of walls to successively lower in stages. Powder material is layered into the build area at each stage and is selectively subjected to a laser beam to fuse the powder material to form an additional layer of a component at each stage. A powder dam extends between the first and second side walls through the build area. The powder dam holds the powder material between the powder dam and the first end wall.

### BACKGROUND OF THE INVENTION

The subject matter herein relates generally to powder bed laser sintering devices.

Powder bed laser sintering (PBLS) is an additive manufacturing technique that uses a high power laser (for example, a Ytterbium fiber laser) to fuse small particles of plastic, metal, ceramic, or glass powders into a mass that has a desired three-dimensional shape. Inside a build chamber area, there is a material dispensing platform and a build platform along with a recoater blade used to move new powder over the build platform. The laser selectively fuses powder material by scanning cross-sections generated from a 3-D digital description of the component (for example from a CAD file or scan data) on the surface of a powder bed. After each cross-section is scanned, the powder bed is lowered by one layer thickness, a new layer of material is applied on top, and the process is repeated until the component is completed. The technology fuses the powder material into a solid part by melting it locally using the focused laser beam. The component is built up additively layer by layer, such as using layers 20 micrometers thick. The PBLS process allows for highly complex geometries to be created directly from the 3D CAD data, fully automatically, in hours and without any tooling. The PBLS process produces parts with high accuracy and detail resolution, good surface quality and excellent mechanical properties. Direct metal laser sintering (DMLS) is one particular type of PBLS that fabricates a metal component from metal powder material.

Conventional PBLS devices are not without disadvantages. During the build process, the components need to be surrounded by powder material to ensure complete and even powder deposition for successive layers. When building a small number of components that do not fill up the entire build area, the components are typically built on the powder dispensing side of the build area in order to minimize the amount of powder used. When tall parts are built, the trailing edge of deposited powder can erode away due to gravity as the pile of deposited powder material gets increasingly high compared to the area of the build plate that has little or no powder material thereon. In such circumstance, the powder material can erode and fall away from the build part to cause improper building. A greater amount of powder material is needed to build up the pile at the top where the component is being built. Recycling of the powder material adds time and cost to the process.

A need remains for a PBLS device that conserves powder material used to form components, particularly tall components in the build area of the PBLS device.

### BRIEF DESCRIPTION OF THE INVENTION

In one embodiment, a powder bed laser sintering (PBLS) device is provided including a build platform having a build area defined over a build plate. The build area is bounded by a plurality of walls comprising first and second end walls and first and second side walls extending between the first and second end walls. The build plate is movable relative to the plurality of walls to successively lower in stages. Powder material is layered into the build area at each stage and is selectively subjected to a laser beam to fuse the powder material to form an additional layer of a component at each stage. A powder dam extends between the first and second side walls through the build area. The powder dam holds the powder material between the powder dam and the first end wall.

Optionally, the powder dam may divide the build area into a filled bin and an unfilled bin with the powder material filling the filled bin and with the unfilled bin being mostly devoid of powder material. The build area may be divided into a covered build area and an uncovered build area by the powder dam. The powder material may fill the uncovered build area and the covered build area may restrict the powder material from entering the covered build area. The build area may have a first volume defined between the first and second end walls and the first and second side walls. The powder dam may divide the first volume into a second volume between the powder dam and the first end wall and a third volume between the powder dam and a second end wall where the second volume is less than the first volume. The second volume may be approximately half the first volume.

Optionally, the powder dam may include a curtain and a lid extending between the curtain and the second end wall. The powder dam may be expandable vertically as the build plate is lowered. The build area may include a top with the build plate being movable relative to the top. The powder dam may be fixed to the top and fixed to, and movable with, the build plate. The powder dam may include a plurality of panels where additional panels are used in the powder dam as the build plate is lowered. The powder dam may be variably positionable along the side walls to change a width between the powder dam and the first end wall.

Optionally, the PBLS device may include a recoater blade movable along the build area to deposit the powder material in the build area. The PBLS device may include a laser source emitting a laser beam into the powder material to selectively fuse the powder material. The build chamber may include a powder supply area adjacent to the build area and a powder discharge area adjacent to the build area. The build area is positioned between the powered supply area and the powered discharge area. The powder dam may include a curtain and a lid extending between the curtain and the powder discharge area where the powder material passing over the lid into the powder discharge area.

In another embodiment, a build chamber is provided for a powder bed laser sintering (PBLS) device. The build chamber includes a powder supply area supplying powder material used for fabricating a component and a build area defined over a build plate. The build area is bounded by a plurality of walls comprising first and second end walls and first and second side walls extending between the first and second end walls. The build plate is movable relative to the plurality of walls to successively lower in stages. Powder material is layered into the build area at each stage and is selectively subjected to a laser beam to fuse the powder material to form an additional layer of a component at each stage. A powder dam extends between the first and second side walls through the build area. The powder dam holds the powder material between the powder dam and the first end wall.

### BRIEF DESCRIPTION OF THE DRAWINGS

FIG. 1 illustrates a powder bed laser sintering (PBLS) device used to fabricate one or more components.

FIG. 2 illustrates the PBLS device at a different stage, which is a later stage than the stage illustrated in FIG. 1.

FIG. 3 illustrates the PBLS device showing a recoater blade thereof pushing powder material through a build chamber.

FIG. 4 is a top perspective view of a portion of the build chamber.

FIG. 5 is a top perspective view of the build chamber showing a powder dam positioned in a build area.

FIG. 6 illustrates the build area without the powder dam.

FIG. 7 is a side view of a portion of the build chamber showing the powder dam supporting powder material for fabricating components.

FIG. 8 illustrates the build area without the powder dam.

FIG. 9 illustrates a portion of the powder dam formed in accordance with an exemplary embodiment.

### DETAILED DESCRIPTION OF THE INVENTION

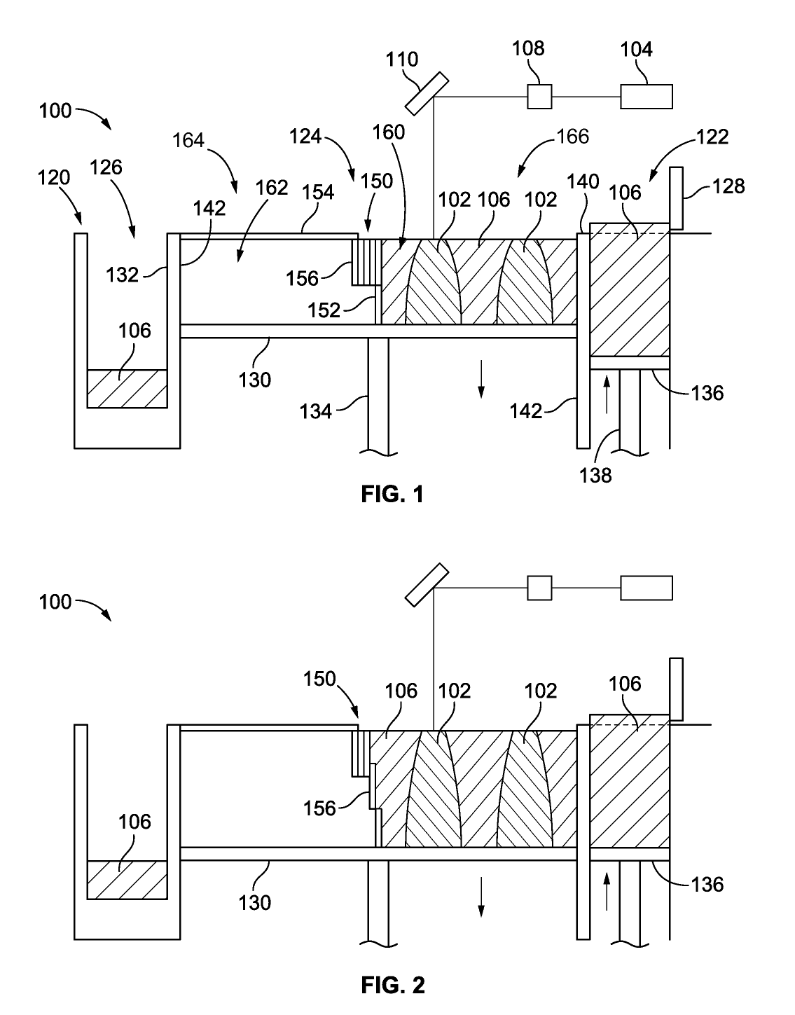

FIG. 1 illustrates a powder bed laser centering (PBLS) device 100 used to fabricate one or more components 102. The PBLS device 100 uses an additive manufacturing technique to build up the components 102 in stages or layers. The PBLS device 100 uses a high power laser 104 to fuse small particles, such as metal particles, plastic particles, ceramic particles, glass particles and the like into a mass that has a desired three-dimensional shape. The laser 104 selectively fuses powder material 106 by scanning cross sections of the components 102 on the surface of the powder material 106. The laser 104 may direct a laser beam through optical components 108, such as lenses, into a scanning mirror 110 that directs the laser beam toward the powder material 106 to form the components 102. The scanning mirror 110 is movable in X and Y directions to direct the laser beam at different areas of the power material 106 to form the components 102.

The PBLS device 100 includes a build chamber 120 that holds the powder material 106 and components 102. The build chamber 120 may be enclosed. In an exemplary embodiment, the build chamber 120 is divided into three sections, a powder supply area 122, a build area 124, and a powder discharge area 126. The powder material 106 is supplied in the powder supply area 122. The powder material 106 is moved from the powder supply area 122 to the build area 124 by a recoater blade 128 or other movable structure capable of moving the powder material 106 from the powder supply area 122 to the build area 124. For example, the recoater blade 128 scrapes a top layer of powder material 106 from the powder supply area 122 and spreads the powder material across the build area 124 to form a layer of powder material 106 at a top of the build area 124. The loose powder material 106 is scanned by the laser beam to form another layer of the components 102. In an exemplary embodiment, the recoater blade 128 pushes the powder material 106 across the build area 124 and excess powder material 106 is deposited in the powder discharge area 126. The powder material 106 in the powder discharge area 126 may be recovered and reused.

In an exemplary embodiment, the build chamber 120 includes a build plate 130 below the build area 124. The build plate 130 is movable relative to a frame 132 of the build chamber 120. For example, during the build process, the build plate 130 may be successively lowered in stages to allow additional layers of powder material 106 to be deposited over the top of the build area 124 and build plate 130. For example, after each cross section of the component 102 is scanned, the build plate 130 is lowered by one layer thickness and a new layer of powder material 106 may be deposited on top of the build plate 130 and components 102. Each layer thickness may be approximately 20 micrometers; however other layer thicknesses are possible in alternative embodiments depending on the material characteristics and type of laser used for fabricating the components 102. The process is repeated until the components 102 are completed. A piston 134 may support the build plate 130 and lower the build plate 130 to the different stages.

In an exemplary embodiment, the build chamber 120 includes a supply plate 136 in the powder supply area 122. The supply plate 136 is supported by a piston 138. The supply plate 136 is movable relative to the frame 132. For example, the supply plate 136 may be successively raised in stages to supply a new layer of powder material 106 that may be spread by the recoater blade 128. As the supply plate 136 is raised upward, the powder material 106 is raised above a top 140 of the frame 132. The recoater blade 128 travels near the top of the frame 132 to push the layer of powder material 106 across the build area 124.

In an exemplary embodiment, the build chamber 120 includes a plurality of walls 142 that form the powder supply area 122, build area 124, and powder discharge area 126. The build plate 130 is movable relative to the walls 142. The supply plate 136 is movable relative to the walls 142.

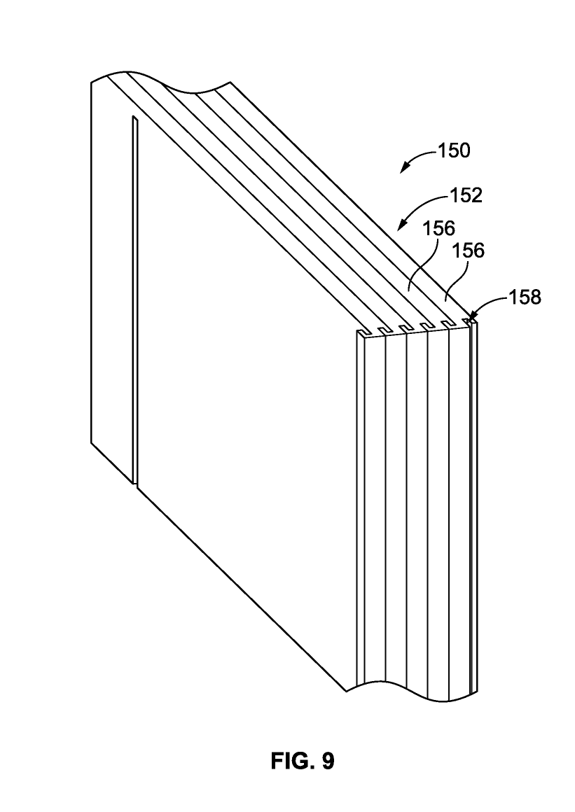

In an exemplary embodiment, the PBLS device 100 includes a powder dam 150 provided in the build area 124. FIG. 9 illustrates a portion of the powder dam 150 formed in accordance with an exemplary embodiment. The powder dam 150 reduces the size of the build area 124. For example the powder dam 150 may reduce the volume of the build area 124 that needs to be filled with powder material 106 to form the components 102. For example, when a small number of components 102 are being formed, or when the entire build area 124 is not needed to form the components 102, the powder dam 150 may be positioned in the build area 124 to limit the area that is filled with the powder material 106. For example, the forming area of the components 102 may be positioned at the end of the build area 124 proximate to the powder supply area 122. The powder dam may be positioned proximate to the outer edge of the forming area of the components 102.

The powder dam 150 supports the powder material 106 to contain the powder material 106 around the components 102. The powder dam 150 may prevent gravity erosion of the powder material 106 into an area over the build plate 130 that has no powder material 106 deposited on it. As such, only enough powder material 106 needed to apply a fresh layer onto the components 102 needs to be spread across the build area 124 for each new layer. The amount of powder material 106 needed to make the components 102 is reduced. The powder dam 150 contains the powder material 106 on a small part of the build plate 130 and reduces the amount of powder material 106 that needs to be recycled. For example, less powder material 106 is needed to form the components 102 than when the powder dam 150 is not used, in which case additional powder material 106 is spread across the entire build area 124 as opposed to being contained in a smaller area over the build plate 130.

In an exemplary embodiment, the powder dam 150 includes a curtain 152 extending generally vertically and a lid 154 extending generally horizontally. The curtain 152 extends between the build plate 130 and the lid 154. In an exemplary embodiment, the curtain 152 is expandable to allow the curtain 152 to move downward with the build plate 130 as the build plate 130 is lowered at each successive stage. The curtain 152 is expandable in a vertical direction. With addition reference to FIG. 9, in an exemplary embodiment, the curtain 152 includes a plurality of panels 156 that are connected together. The panels 156 may be spread out as the build plate 130 is lowered. In an exemplary embodiment, a first of the panels 156 is fixed to the build plate 130 and a last of the panels 156 is fixed to the lid 154. As the build plate 130 is lowered, the panels 156 are pulled apart such that the curtain 152 expands the entire height between the build plate 130 and the lid 154. The panels 156 may be held together in a track or rail 158 at an edge of each panel 156. The rail 158 allows successive panels 156 to be moved (e.g. lowered or raised) relative to the adjacent panels 156 with the build plate 130. The panels 156 may be held together by other means or features in alternative embodiments.

In an exemplary embodiment, the lid 154 extends between the curtain 152 and the powder discharge area 126. The lid 154 may be provided along the top 140. As the recoater blade 128 pushes the powder material 106 across the build area 124, excess powder passes along the lid 154 and is deposited into the powder discharge area 126. The lid 154 stops the powder material 106 from getting behind the curtain 152 in the build area 124. If excess powder material 106 were able to fall over the back side of the curtain 152, the powder material 106 could create a dust cloud that could interfere with the laser beam and the sintering process. The lid 154 prevents the dust cloud from forming by allowing the excess powder material 106 to be deposited directly into the powder discharge area 126, as originally intended.

The powder dam 150 divides the build area 124 into a filled bin 160 and an unfilled bin 162. The powder material 106 is able to fill the filled bin 160. The unfilled bin 162 is mostly devoid of powder material 106. For example, the lid 154 stops the powder material 106 from entering the unfilled bin 162. The powder dam 150 divides the build area 124 into a covered build area 164 and an uncovered build area 166. The filled bin 160 defines the uncovered build area 166 while the unfilled bin 162 defines the covered build area 164. The lid 154 forms a cover over the covered build area 164. The powder material 106 is able to fill the uncovered build area 166.

FIG. 2 illustrates the PBLS device 100 at a different stage, which is a later stage than the stage illustrated in FIG. 1. With additional reference to FIG. 1, the build plate 130 is show at a lower stage or lower position than the position shown in FIG. 1. The supply plate 136 is shown at a higher stage or higher position than the stage shown in FIG. 1. The components 102 have additional layers formed. The powder dam 150 has been expanded. Additional panels 156 are used in the powder dam 150 to support the powder material 106. For example, as the build plate 130 is lowered, additional panels 156 are pulled out of the stack to form supporting panels. Supporting panels are defined as those panels that directly support the powder material 106 (e.g. the panels that touch the powder material). For example, FIG. 2 illustrates three supporting panels while FIG. 1 only illustrates two supporting panels.

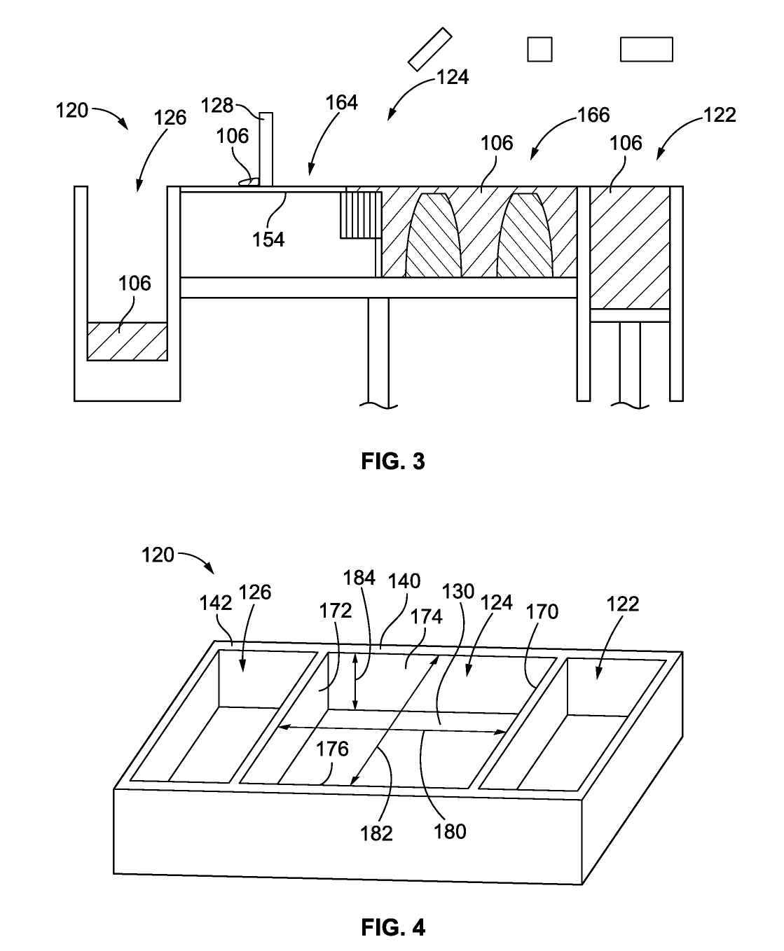

FIG. 3 illustrates the PBLS device 100 showing the recoater blade 128 pushing the powder material 106 across the build area 124 toward the powder discharge area 126. The recoater blade 128 is moved linearly through the build chamber 120 from an initial position (shown in FIGS. 1 and 2) to a final position where the recoater blade 128 is at the powder discharge area 126. In the final position, the excess powder material 106 is pushed into the powder discharge area 126. The recoater blade 128 moves along intermediate positions across the powder supply area 122 and build area 124. FIG. 3 illustrates the recoater blade 128 in an intermediate position where the recoater blade 128 has passed over the uncovered build area 166 and is shown positioned over the covered build area 164. The recoater blade 128 passes along the lid 154 and pushes the powder material 106 across the lid 154 to the powder discharge area 126.

FIG. 4 is a top perspective view of a portion of the build chamber 120. The walls 142 define the powder supply area 122, the build area 124 and the powder discharge area 126. In an exemplary embodiment, the build area 124 is defined by first and second end walls 170, 172 and first and second side walls 174, 176. In the illustrated embodiment, the build area 124 is rectangular; however the build area 124 may have other shapes in alternative embodiments. The build area 124 may be defined by additional walls 142 in alternative embodiments. The build plate 130 is provided at a bottom of the build area 124. The build plate 130 has a complementary shape as the shape of the build area 124.

The build area 124 has a width 180 defined between the first and second end walls 170, 172. The build area 124 has a lateral width 182 defined between the first and second side walls 174, 176. The build area 124 has a height 184 measured between the build plate 130 and the top 140 of the frame 132. In an exemplary embodiment, the height 184 is variable during operation of the PBLS device 100 as the build plate 130 is successively lowered to form new layers on the top of the components 102 as the components 102 are being fabricated.

The build area 124 has a first volume defined between the first and second end walls 170, 172 and the first and second side walls 174, 176 as well as between the top 140 and the build plate 130. The first volume is variable and is increased as the build plate 130 is moved downward during operation of the PBLS device 100.

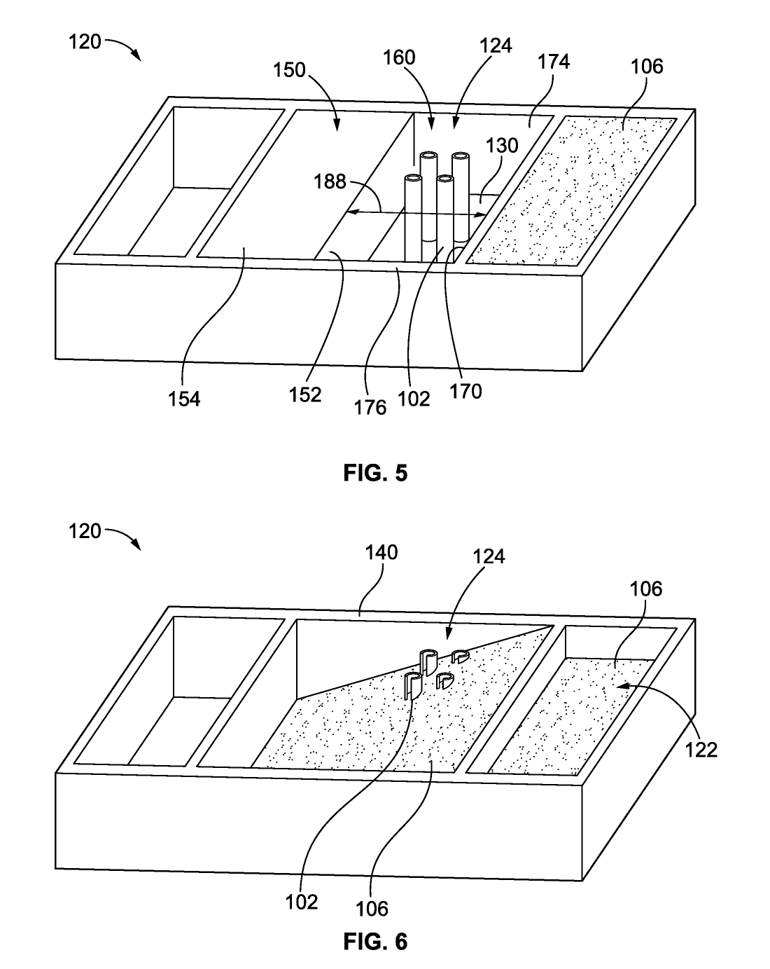

FIG. 5 is a top perspective view of the build chamber 120 showing the powder dam 150 positioned in the build area 124. The powder dam 150 extends between the first and second side walls 174, 176 through the build area 124. The powder dam 150 is configured to hold the powder material 106 (not shown in the build area 124 to illustrate the fabricated components 102) between the powder dam 150 and the first end wall 170. The space between the curtain 152 and the second end wall 172 (shown in FIG. 4) is an empty or unfilled space. In an exemplary embodiment, the powder dam 150 may be selective positionable within the build area 124, such as to control a width 188 of the filled bin 160. The width 188 of the fill bin 160 is defined between the curtain 152 and the first end wall 170.

The powder dam 150 may be attached at different locations along the first and second side walls 174, 176 to position the curtain 152 at different distances from the first end wall 170. In an exemplary embodiment, the powder dam 150 may be attached within the build area 124 by securing the curtain 152 to the side walls 174, 176 and then securing the lid 154 to the curtain 152. In another exemplary embodiment, the powder dam 150 may be coupled to the build area 124 by first attaching the lid 154 to the first and second side walls 174, 176 and then attaching the curtain 152 to the lid 154. The curtain 152 is fixed between the lid 154 and the build plate 130. As the build plate 130 is lowered, the curtain 152 expands to extend the entire height between the build plate 130 and the lid 154.

FIG. 6 illustrates the build area 124 without the powder dam 150 (shown in FIG. 5) showing an example of erosion of the powder material 106. A large amount of additional powder material 106 would be needed from the powder supply area 122 to fill the build area 124 to ensure that powder material is filled to the top 140 in the forming area of the components 102. Having the powder dam 150 in place would greatly reduce the amount of powder material 106 needed, particular for forming taller components 102 by supporting the powder material 106 and eliminating the erosion.

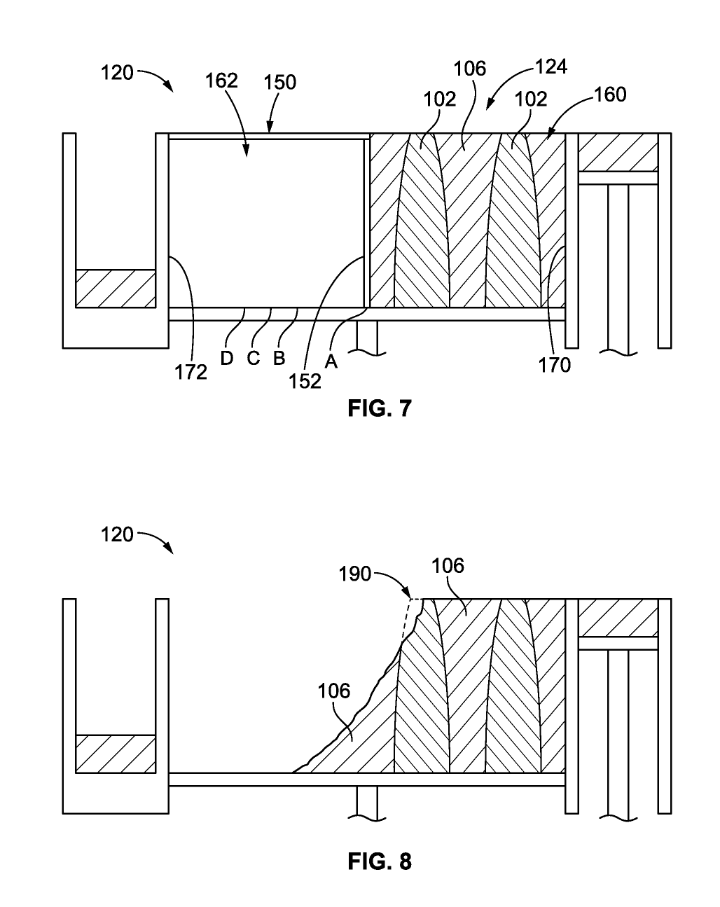

FIG. 7 is a side view of a portion of the build chamber 120 showing the powder dam 150 supporting the powder material 106 for the components 102. As shown in FIG. 7, the powder dam 150 divides the build area 124 into the filled bin 160 and the unfilled bin 162. The first volume is divided by the powder dam 150 into a second volume and a third volume. The second volume is defined between the powder dam 150 and the first end wall 170. The third volume is defined between the powder dam 150 and the second end wall 172. The second volume and the third volume are less than the first volume. The amount of powder material 106 needed to fill the second volume is less than the amount of powder material 106 needed to fill the first volume.

FIG. 7 illustrates the curtain 152 of the powder dam 150 connected at position A. In an exemplary embodiment, the powder dam 150 may be positioned at different locations within the build area 124, such as at position B, position C, position D or other positions. When positioning at other positions, the second volume may be increased while the third volume may be decreased. Other positions closer to the first end wall 170 are possible as well to decrease the second volume even further. In the illustrated embodiment, the second volume is approximately half the first volume.

FIG. 8 illustrates a portion of the build chamber 120 without the powder dam 150 (shown in FIG. 7). FIG. 8 shows an example of erosion of the powder material 106 caused by gravity. When the powder dam 150 is not used, the powder material 106 is unsupported and is able to erode away. Additional powder material 106 would be required to provide support for the eroded area identified by reference numeral 190. When erosion occurs, building tall components becomes difficult or impossible as the required powder material is not positioned where needed.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A powder bed laser sintering (PBLS) device comprising:
a build chamber having a build area defined over a build plate, the build area being bounded by a plurality of walls comprising first and second end walls and first and second side walls extending between the first and second end walls, the build plate being movable relative to the plurality of walls to successively lower in stages, powder material being layered into the build area at each stage, the powder material being selectively subjected to a laser beam to fuse the powder material to form an additional layer of a component at each stage; and
a powder dam extending between the first and second side walls through the build area, the powder dam holding the powder material between the powder dam and the first end wall.

2. The PBLS device of claim 1, wherein the powder dam divides the build area into a filled bin and an unfilled bin, the powder material filling the filled bin, the unfilled bin being mostly devoid of powder material.

3. The PBLS device of claim 1, wherein the build area has a first volume defined between the first and second end walls and the first and second side walls, the powder dam dividing the first volume into a second volume between the powder dam and the first end wall and a third volume between the powder dam and a second end wall, the second volume being less than the first volume.

4. The PBLS device of claim 3, wherein the second volume as approximately half the first volume.

5. The PBLS device of claim 1, wherein the powder dam comprises a curtain and a lid extending between the curtain and the second end wall.

6. The PBLS device of claim 1, wherein the powder dam is expandable vertically as the build plate is lowered.

7. The PBLS device of claim 1, wherein the build area includes a top, the build plate being movable relative to the top, the powder dam being fixed to the top, the powder dam being fixed to, and movable with, the build plate.

8. The PBLS device of claim 1, wherein the powder dam comprises a plurality of panels, additional panels being used in the powder dam as the build plate is lowered.

9. The PBLS device of claim 1, wherein the powder dam is variably positionable along the side walls to change a width between the powder dam and the first end wall.

10. The PBLS device of claim 1, further comprising a recoater blade movable along the build area to deposit the powder material in the build area.

11. The PBLS device of claim 1, wherein the build chamber comprises a powder supply area adjacent to build area and a powder discharge area adjacent to build area, the build area being positioned between the powered supply area and the powered discharge area, the powder dam comprising a curtain and a lid extending between the curtain and the powder discharge area, the powder material passing over the lid into the powder discharge area.

12. The PBLS device of claim 1, wherein the build area is divided into a cover build area and an uncovered build area by the powder dam, the powder material filling the uncovered build area, the covered build area restricting the powder material from entering the covered build area.

13. The PBLS device of claim 1, further comprising a laser emitting a laser beam into the powder material to selectively fuse the powder material.

14. A build chamber for a powder bed laser sintering (PBLS) device comprising:
a powder supply area supplying powder material used for fabricating a component;
a build area defined over a build plate, the build area being bounded by a plurality of walls comprising first and second end walls and first and second side walls extending between the first and second end walls, the build plate being movable relative to the plurality of walls to successively lower in stages, the powder material from the powder supply area being layered into the build area at each stage, the powder material being selectively subjected to a laser beam to fuse the powder material to form an additional layer of a component at each stage; and
a powder dam extending between the first and second side walls through the build area, the powder dam holding the powder material between the powder dam and the first end wall.

15. The build chamber of claim 14, wherein the powder dam divides the build area into a filled bin and an unfilled bin, the powder material filling the filled bin, the unfilled bin being mostly devoid of powder material.

16. The build chamber of claim 14, wherein the build area has a first volume defined between the first and second end walls and the first and second side walls, the powder dam dividing the first volume into a second volume between the powder dam and the first end wall and a third volume between the powder dam and a second end wall, the second volume being less than the first volume.

17. The build chamber of claim 14, further comprising a recoater blade moving across the powder supply area and the build area to move the powder material from the powder supply area to the build area.

18. The build chamber of claim 14, wherein the powder dam comprises a curtain and a lid extending between the curtain and the second end wall.

19. The build chamber of claim 14, wherein the powder dam is expandable vertically as the build plate is lowered.

20. The build chamber of claim 14, further comprising a powder discharge area adjacent to build area, the build area being positioned between the powered supply area and the powered discharge area, the powder dam comprising a curtain and a lid extending between the curtain and the powder discharge area, the powder material passing over the lid into the powder discharge area.
